(19) United States
(12) Patent Application Publication
(10) Pub. No.: US 2009/0057515 A1
(43) Pub. Date: Mar. 5, 2009

(54) HOOK FOR SUSPENDING OBJECT

(75) Inventor: Minlon Chuang, Shenzhen (CN)

Correspondence Address: HAMRE, SCHUMANN, MUELLER & LARSON, P.C., P.O. BOX 2902, MINNEAPOLIS, MN, 55402-0902, US

(73) Assignee: Homesite Corporation Co., Ltd., Shenzhen (CN)

(21) Appl. No.: 12/183,498

(22) Filed: Jul. 31, 2008

(30) Foreign Application Priority Data
Aug. 27, 2007 (CN) 200720122517.3

(51) Int. Cl. A47G 29/02; F16M 13/00

(52) U.S. Cl. 248/305; 248/316.3; 248/316.5; 248/306

(57) ABSTRACT

The present invention discloses a hook for suspending an object. The hook is fixed on a bracket with at least one pillar and comprises at least one hook groove, a shaft, and a locking member. The hook groove receives the pillar. Each hook groove has a first opening defined between two projecting portions extending from the hook. The locking member is adjacent to one hook groove and comprises a locking part pivotally engaging the shaft and defining a locking groove with a second opening between two end portions thereof One of the two end portions and one projecting portions opposite to the one end portions cooperatively defines a locking opening. The locking opening has an opening dimension smaller than dimension of the pillar. When the hook engages the bracket, the opposing end portion and projecting portion press against the pillar to hold the pillar in the locking groove.

### FIELD OF THE INVENTION

The present invention relates to hook assemblies and, more particularly to a hook for suspending object.

### BACKGROUND

A hook is typically utilized to suspend an object onto a bracket. For example, a liquid crystal display (LCD) can be mounted onto a bracket through coupling the hook to the bracket fixed on a wall. A traditional hook directly engages the bracket and then is locked to the bracket by manual. In general, the user readily forgets to lock the hook. Further, in such a manner, the hook would become loose on the bracket for a long time. As a result, the liquid crystal display readily departs from the bracket, for example, due to an undue slight collision. Consequently, the liquid crystal display falls off from the bracket and thus is subjected to breakage.

### SUMMARY

It is therefore an object of the present invention to provide a hook for suspending object, which has a self-locking function and does not readily depart from the bracket.

In accordance with an embodiment of the present invention, a hook for suspending object comprises at least one hook groove, a shaft disposed on the hook, and a locking member. The at least one hook groove is configured for engaging at least one pillar of the bracket. Each hook groove has a first opening defined between two protrusions extending from the hook. The locking member is adjacent to one hook groove. The locking member comprises a locking part pivotally engaging the shaft. The locking part defines a locking groove with a second opening between two end portions thereof. One of the two end portions and one protrusion opposite to the one end portions cooperatively defines a locking opening. The locking opening has an opening dimension smaller than dimension of the pillar. When the hook engages the bracket, the opposing end portion and protrusion press against the pillar to hold the pillar in the locking groove.

While fixing the hook to the bracket, the locking part revolves around the shaft so that the pillar can be inserted into the hook groove, thereby fixing the hook on the bracket. While the locking part is driven to revolve around the shaft to depart from the pillar, the pillar escapes from the hook groove, thereby readily take the hook away from the bracket. Accordingly, the hook has a self-locking function and does not readily depart from the bracket so as to prevent object from falling off and becoming breakage.

Other objects, advantages and novel features of the present invention will become more apparent from the following detailed description when taken in conjunction with the accompanying drawings, in which:

### BRIEF DESCRIPTION OF THE DRAWINGS

FIG. 1 is a schematic, isometric view of a hook according to a preferred embodiment of the present invention;

FIG. 2 is a schematic, isometric view of the hook of FIG. 1 suspended on a bracket;

FIG. 3 is a schematic, side view of a locking member disposed in a receiving groove of FIG. 1; and

FIG. 4 is a schematic, structural view of an operation process of engaging the hook of FIG. 1 onto the bracket.

### DETAILED DESCRIPTION OF THE PREFERRED EMBODIMENTS

Objects, advantages and embodiments of the present invention will be explained below in detail with reference to the accompanying drawings. However, it is to be appreciated that the following description of the embodiment(s) is merely exemplary in nature and is no way intended to limit the invention, its application, or uses.

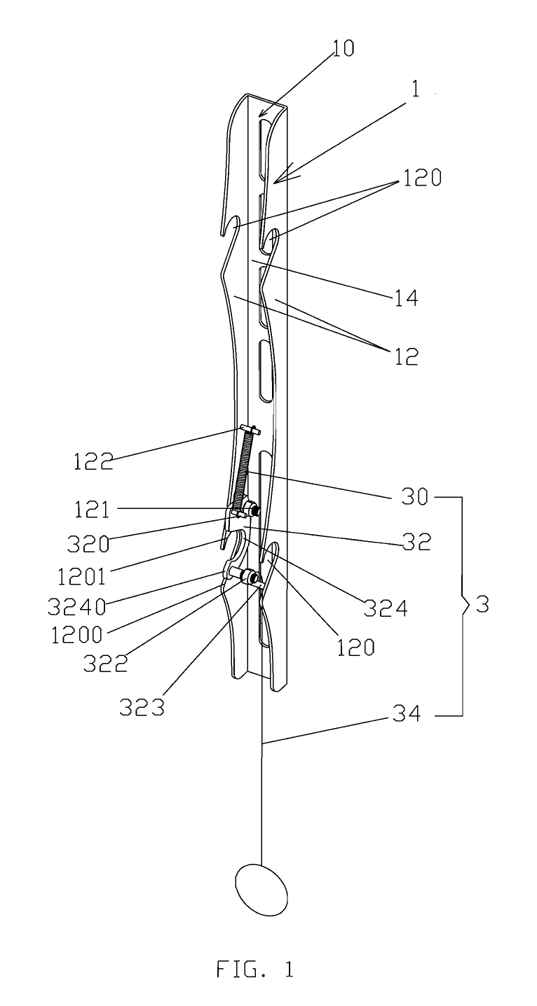

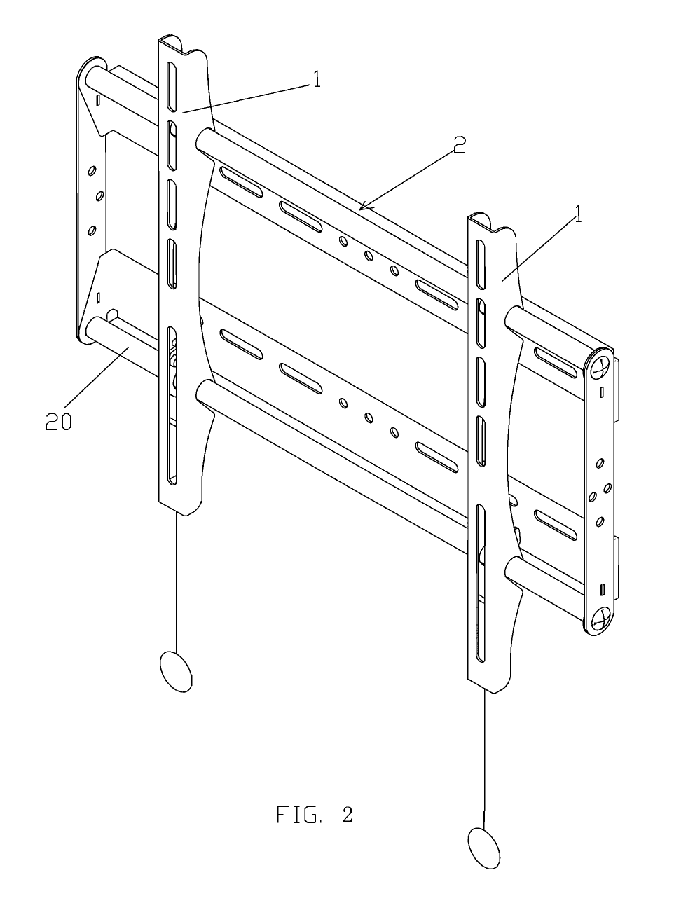

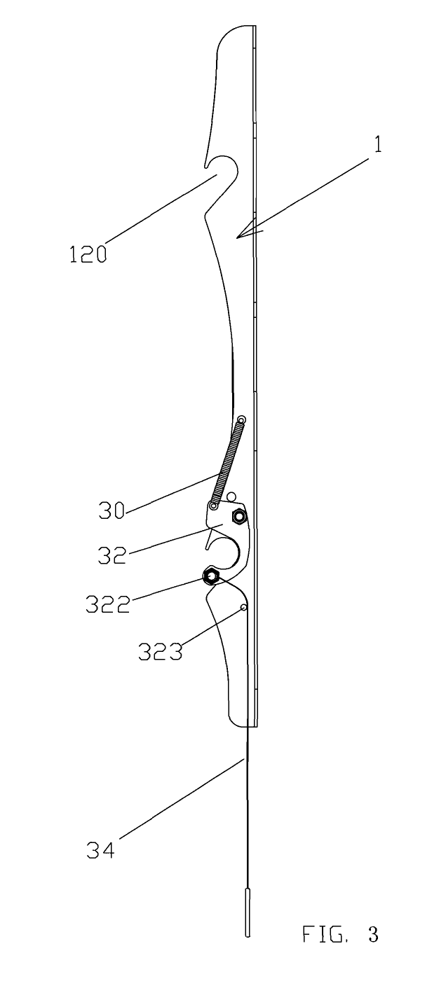

Referring to FIGS. 1 through 4, a hook 1 for suspending object is illustrated, in accordance with a preferred embodiment of the present invention. In this embodiment, the hook 1 is used to fix a liquid crystal display (not shown). As shown in FIG. 2, the hook 1 is typically used to engage a bracket 2, which is mounted on a wall. At least one pillar 20 is disposed on the bracket 2. In the illustrated embodiment, two pillars 20 are disposed on the bricked 2 and are parallel to one another in a horizontal direction. The two pillars 20 include an upper pillar and a lower pillar. It is to be appreciated that the hook 1 could engage any other apparatus with at least one pillar.

The hook 1 has an elongated shape and includes a substrate 14 and two parallel upright sidewalls 12 respectively projecting from elongated edges of the substrate 14. The substrate 14 and the sidewalls construct a hook body of the hook 1. The two sidewalls 12 and the substrate 14 cooperatively define a receiving groove 10.

Each of the two sidewalls 12 defines an upper and a lower hook grooves 120. Distance between the two grooves 120 of each sidewall is essentially similar and corresponding to distance between the two pillars 20. The upper hook grooves 120 of the two sidewalls 12 are advantageously aligned in a horizontal direction. The lower hook grooves 120 of the two sidewalls 12 are advantageously aligned in a horizontal direction. The pillars 20 are snapped into the respective hook grooves 120, thereby fixing the hook 1 onto the bracket 2.

At least one locking member 3 is disposed at a groove wall (e.g., sidewall 120) of the receiving groove 10 and is adjacent to one hook groove 120 in one sidewall 12. In this embodiment, one locking member 3 is applied in the receiving groove IO and is adjacent to a lower hook groove 120. The locking member 3 includes an elastic member such as a spring 30, a locking part 32, and an unlocking part 34. A first pole 122 is projected from one sidewall 120 of the receiving groove 10. A shaft 121 is projected from one sidewall 120 of the receiving groove 10. An end of the locking part 32 pivotally engages the shaft 121. The shaft 121 is disposed over the lower hook groove 120 and is interposed between the first pole 122 and the lower hook groove 120. A second pole 320 is projected from the locking part 32. The second pole 320 is disposed at a side nearby the shaft 121. Two ends of the spring 30 are fixed on the first and second poles 122 and 320, respectively. A guide pole 322 is projected from a lower portion of the locking part 32. A projection 323 protrudes from one sidewall 12 of the receiving groove 10. The projection 323 is disposed below the guide pole 322 and is more adjacent to the substrate 14 than the guide pole 322. An end of the unlocking part 34 is connected to the guide pole 322 while the other end partially runs around the projection 323. In this embodiment, the unlocking part 34 is but not limited to an enough long metal chain or a string.

The locking part 32 is parallel and adjacent to the sidewalls 12. For example, the locking part 32 is beneficially a panel parallel to the sidewalls 12. The locking part 32 defines a locking groove 324. The locking groove 324 has a corresponding shape to the hook groove 120 of the sidewall 120. The locking groove 324 is usefully aligned with the hook groove 120 along an elongated direction of the pillars 20. The locking groove 324 faces toward the same direction to the facing of the hook groove 120. The locking groove 324 cooperating with the hook groove 120 achieves a self-locking function. The sidewall 12 extends an upper protrusion 1201 and a lower protrusion 1200 cooperatively defining a first opening of the hook groove 120 and surrounding the groove 120. The locking part 32 has two end portions defining a second opening of the locking groove 324. The two end portions are an upper end portion (not labeled) and a lower end portion 3240. The first opening is substantially aligned with the second opening of the locking groove 324. The hook groove 120 and the locking groove 324 have a U-shaped void. The lower end portion 3240 is a hook-shaped end. The lower end portion 3240 is slight higher than the upper projection 1201 in relation to the substrate 14 or bottom of the hook groove 120. The upper projection 1201 and the lower end portion 3240 cooperatively define a locking opening slight smaller than a diameter of the pillar 20. The lower end portion 3240, i.e., the hook-shaped end portion, may define an orifice so that the unlocking part 34 can be connected to the lower end portion 3240 by binding through the orifice.

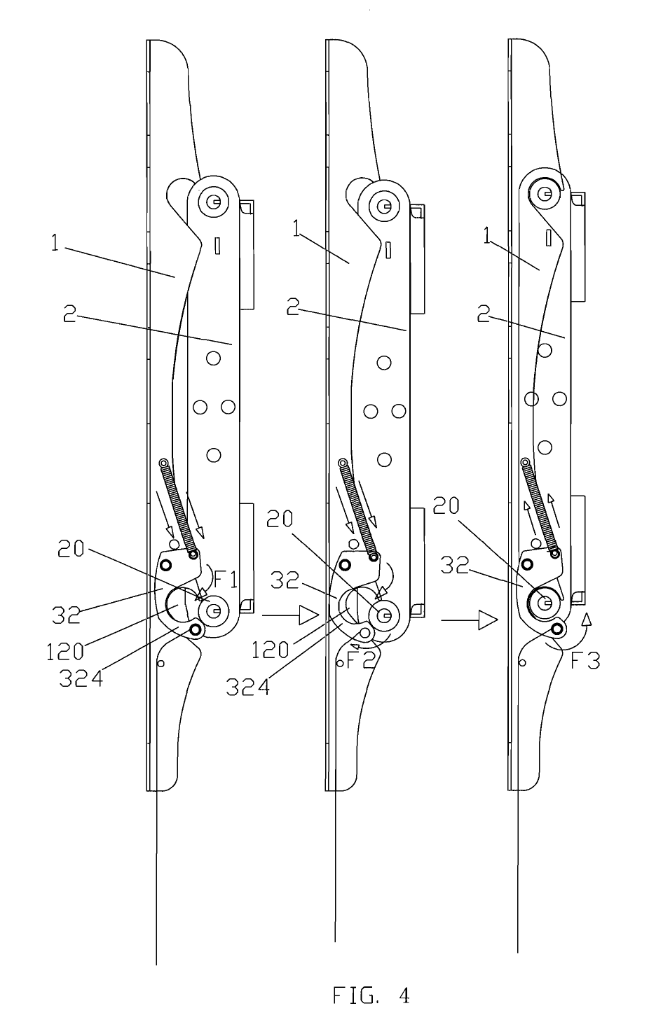

Referring to FIG. 4 again, the hook 1 is suspended onto the bracket 2. The upper and lower hook grooves 120 of the hook 1 are hooked on the two pillars 20 of the bracket 2, respectively. While the hook groove 120 adjacent to the locking groove 324 is placed over and moves toward the lower pillar 20 of the bracket 2, the lower pillar 20 splay out the lower end portion 3240 along F1 direction shown in FIG. 4. The locking part 32 thereby revolves about the shaft 121 along a clockwise direction, i.e., F2 direction shown in FIG. 4. Then the spring 30 is stretched and the lower pillar 20 is inserted into the locking groove 324 and the hook groove 120. The locking part 32 stop revolving along F2 direction and the lower pillar 20 cease to force the locking part 32 to revolve, after the entire circumference of the lower pillar 20 is received in the hook groove 120. The spring 30 try to restore its original status due to withdrawal of external restrain, thereby causing the locking part 32 to revolve about the shaft 121 along a counter clockwise direction i.e., F3 direction shown in FIG. 4. The locking part 32 substantially returns to original status. Accordingly, the lower end portion 3240 press ageist the lower pillar 20. Since the locking opening defined between the upper projection 1201 and the lower end portion 3240 is smaller than the diameter of the lower pillar 20, the upper projection 1201 and the lower end portion 3240 cooperatively hold the lower pillar 20 in the hook groove 120, thereby locking the hook 1 onto the lower pillar 20. Advantageously, in the entire locking process, for example, during the rotation of the locking member 3, the spring 30 is in a stretched status to reinforce restriction action of the lower end portion 3240 to the lower pillar 20.

The disassembling of the hook from the bracket 2 is described as below. Initially, a free end of the unlocking part 34 is drawn or pulled, for example, by a hand. Then the unlocking part 34 runs around the projection 323 of the receiving groove 10, thereby pulling downward the guide pole 323. Consequently, the locking part 32 revolves around the shaft 121 along a clockwise direction and thereby the lower end portion 3240 releases the restriction to the lower pillar 20. While the locking opening is enlarged enough to allow the lower pillar 20 to escape from the hook groove 120, the hook 1 is readily taken down from the bracket 2.

It is to be understood that the elastic member could use various elements having elasticity other than the spring 30 to provide elastic tension and restriction to rotation of the locking part 32.

In use for fixing an LCD on the bracket 2, the hook 1 is firstly fixed onto the LCD. Then the at least one hook 1 (e.g., two hooks 1 as shown in FIG. 2) with the LCD is fixed on the bracket 2 on a wall according to locking operation described above, thereby achieving the fixation of the LCD on the wall.

The hook 1 is tightly fastened on the bracket 2 using the locking member 3 so as to prevent the hook 1 from escaping from the bracket 2. It is to be appreciated that the hook 1 can be used but not limited to suspend the LCD.

It is believed that the present embodiments and their advantages will be understood from the foregoing description, and it will be apparent that various changes may be made thereto without departing from the spirit and scope of the invention or sacrificing all of its material advantages, the examples hereinbefore described merely being preferred or exemplary embodiments of the invention.

What is claimed is:

1. A hook for suspending object configured for engaging a bracket, the hook comprising:
at least one hook groove configured for respectively receiving at least one pillar of the bracket, each hook groove having a first opening defined between two opposite protrusions extending from the hook;
a shaft disposed on the hook; and
a locking member disposed adjacent to one hook groove, the locking member comprising a locking part pivotally engaging the shaft, the locking part comprising a locking groove having a second opening defining between two opposite end portions thereof, one of the two end portions and one protrusions opposite to the one end portions cooperatively defining a locking opening having an opening dimension smaller than diameter of the pillar;
when the hook engages the bracket, the opposite end portion and protrusion press against the pillar to hold the pillar in the locking groove.

2. The hook as claimed in claim 1, further comprising an elastic member having two ends connected to the hook and the locking member respectively.

3. The hook as claimed in claim 2, wherein the elastic member is in a stretched status during the locking member revolves around the shift.

4. The hook as claimed in claim 2, wherein the elastic member is a spring.

5. The hook as claimed in claim 1, wherein the locking member further comprises an unlocking part, the unlocking part being configured for causing the end portion defining the locking opening to depart from the pillar, the unlocking part connecting an end of the locking part away from the shaft.

6. The hook as claimed in claim 5, wherein a guide pole protrudes from the locking member, a projection protruding from the hook, the unlocking part running around the projection and connecting the guide pole.

7. The hook as claimed in claim 5, wherein the unlocking part is a chain or a string.

8. The hook as claimed in claim 1, wherein the end portion and the protrusion cooperatively defining the locking opening are respectively a lower end portion and an upper protrusion, the lower end portion having a height in relation to bottom of the hook groove higher than that of a lower protrusion opposite to the upper protrusion.

9. The hook as claimed in claim 1, wherein the hook comprises a substrate and two sidewalls respectively projecting from elongated edges of the substrate, the substrate and the two sidewalls cooperatively defining a receiving groove, each hook groove being defined in one respective sidewall, the locking member being disposed at one sidewall.

10. The hook as claimed in claim 1, wherein the object is a liquid crystal display fixed on the hook, the bracket being mounted on a wall.

11. A hook comprising:
a hook body, the hook body defining at least one hook groove, each hook groove being configured for receiving a fixed pillar, each hook groove being defined by two protrusions extending from the hook body;
a locking member disposed adjacent to one hook groove, the locking member comprising a locking part pivotally engaging the hook body, the locking part comprising a hook-shaped end portion, the hook-shaped end portion being opposite to one protrusion, the hook-shaped end portion and the opposite protrusion cooperatively defining a locking opening, the locking opening having an opening dimension smaller than diameter of the pillar;
when the hook engages the fixed pillar, the opposite hook-shaped end portion and protrusion press against the pillar to hold the pillar in the locking groove.

12. The hook as claimed in claim 1, further comprising an elastic member having two ends connected to the hook body and the locking member respectively.

13. The hook as claimed in claim 12, wherein the elastic member is in a stretched status during the locking member revolves around the shift.

14. The hook as claimed in claim 12, wherein the elastic member is a spring.

15. The hook as claimed in claim 11, wherein the locking member further comprises an unlocking part, the unlocking part being configured for causing the hook-shaped end portion to depart from the pillar, the unlocking part connecting the hook-shaped end portion.

16. The hook as claimed in claim 15, wherein a guide pole protrudes from the locking member, a projection protruding from the hook body, the unlocking part running around the projection and connecting the guide pole.

17. The hook as claimed in claim 15, wherein the unlocking part is a chain or a string.

18. The hook as claimed in claim 11, wherein the hook-shaped end portion and the protrusion cooperatively defining the locking opening are respectively a lower end portion and an upper protrusion, the lower end portion having a height in relation to bottom of the hook groove higher than that of a lower protrusion opposite to the upper protrusion.

19. The hook as claimed in claim 11, wherein the hook body comprises a substrate and two sidewalls respectively projecting from elongated edges of the substrate, the substrate and the two sidewalls cooperatively defining a receiving groove, each hook groove being defined in one respective sidewall, the locking member being disposed at one sidewall.
